(19) United States
(12) Patent Application Publication
(10) Pub. No.: US 2015/0019208 A1
(43) Pub. Date: Jan. 15, 2015

(54) METHOD FOR IDENTIFYING A SET OF SENTENCES IN A DIGITAL DOCUMENT, METHOD FOR GENERATING A DIGITAL DOCUMENT, AND ASSOCIATED DEVICE

(71) Applicant: MINING ESSENTIAL, Vitry sur Seine (FR)

(72) Inventor: Abderrafih LEHMAM, Vitry sur Seine (FR)

(73) Assignee: MINNING ESSENTIAL, Vitry sur Seine (FR)

(21) Appl. No.: 14/377,790

(22) PCT Filed: Feb. 8, 2013
(86) PCT No.: PCT/FR2013/050269

§ 371 Date: Aug. 8, 2014

(30) Foreign Application Priority Data
Feb. 9, 2012 (FR) 1251241

(51) Int. Cl. G06F 17/27

(52) U.S. Cl. CPC G06F 17/2705
USPC 704/9

(57) ABSTRACT

A method for generating a digital summary, the method including: a parameterisation step for defining a first degree of summarisation of a first digital document defining a first ratio between a first number representing the quantity of data contained in the desired digital abstract and a second number representing the quantity of data contained in the first document; an analysis step for analysing the first digital document, including the definition of a set of terms, known as TAG; a segmentation step for (i) determining a first set of sentences in the first document or (ii) associating a weighing with each of the sentences; an extraction step for extracting a number of sentences according to the degree of condensation; and a generation step for generating a digital abstract including a set of ordered sentences.

### FIELD

The invention relates to the field of methods and systems for extracting relevant operable data according to some criteria of a corpus of digital documents. More particularly, the field of the invention relates to methods for generating a summary of a digital document some characteristics of which are parameterisable.

### STATE OF THE ART

Presently, some methods enable, from a digital document, passages or excerpts of this document to be identified based on a statistical method. These methods aim at extracting data from a digital document, for example words or sentences, as a function of hits of some predefined TAGS in the document.

The present methods for dynamically generating a summary of a digital document do not seem to offer a sufficient consistency and accuracy level to be operable by a user.

Indeed, an issue of these methods lies in enabling a user to access the essential elements of a digital document by means of generating a summary. The latter must have a sufficient consistency and accuracy to be operable. The present methods are based on a semantics defined by a user, for example by defining key words, which is not sufficient in itself to maintain a consistency and a meaning of the digital document. It is even possible, by using such methods, to distort the consistency of a digital document or to generate a misinterpretation by decontextualizing some data of the digital document.

### SUMMARY OF THE INVENTION

The invention enables the abovementioned drawbacks to be resolved.

The object of the invention is a method for identifying a set of sentences in a first digital document. The identification method comprises:
a step for importing a first digital document in at least one predefined format for: either displaying the document in a first interface or storing it in a memory;
a step for selecting, in a base, indicating sentence fragments, known as FPI, each of the terms of which can be defined thanks to a morphological dictionary, said FPI comprising a set of linguistic TAGs, each of the linguistic TAGs comprising a first allocation of numerical values chosen in a first interval defined by a first minimum value and a first maximum value;
a step for segmenting the first digital document for:
   determining a first set of sentences of the first document;
   numbering the sentences of this first set defining a first sequence;
a step for comparing terms of each sentence of the first segmented document and linguistic TAGs of the base of indicating sentence fragments for spotting the presence of linguistic TAGs in said sentences;
a step for weighting each of the sentences by allocating a first score corresponding to the sum of the values of each linguistic TAG spotted in each of the sentences;
a step for identifying a second set of sentences included in the first set of sentences having a weighting higher than a first threshold;

In an improved embodiment, the method for identifying a set of sentences in a first digital document:
the selection step comprises selecting a thesaurus defining a file comprising a list of semantic TAGs of a field, each of the semantic TAGs comprising a second allocation of values for each semantic TAG included in a second interval defined by a second minimum value and a second maximum value;
the step for weighting each of the sentences by allocating a second score corresponding to the sum of the values of each linguistic TAG spotted in each of the sentences.

In another embodiment which can be combined with the previous one,
the selection step comprises selecting a set of TAGs defined by a user defining the user TAGs comprising semantic expressions and/or terms, each of the user TAGs comprising a third allocation of values for each user TAG included in a third interval defined by a third minimum value and a third maximum value;
the step for weighting each of the sentences by allocating a third score corresponding to the sum of values of each user TAG spotted in each of the sentences.

A technical advantage of the characteristics of the invention is that the base of indicating sentence fragments enables the identification of terms or expressions that can include TAGs associated with the structure of a text and with the significance of specific data in a particular context. For example such TAGs can be: “to conclude”, “finally”, “most importantly”, etc.

An advantage of the method of the invention is that the TAGS of the base of indicating sentence fragments are dissociated from key words defined by a user which are likely to arouse his/her interest. Furthermore, a thesaurus can be associated in order to identify sentences according to a precise field, for example the economic field.

Advantageously, the first threshold is calculated based on a condensation rate defined by the number of sentences desired by a user of the second set out of the total number of sentences of the first set of sentences.

Advantageously, the first threshold is calculated based on a condensation rate defined by the number of terms wished by a user of the second set of sentences out of the total number of terms of the first set of sentences.

Advantageously, an interface enables the condensation rate to be configured.

Advantageously, a displaying step by means of an interface of the first digital document comprises generating identified sentences according to a font size larger than the non-identified sentences.

Advantageously, the comparison step (E_COM) comprises determining root terms of the linguistic TAGs of the FPI based on a morphological dictionary and comparing the declensions of the root terms of the linguistic TAGs with each sentence of the digital document.

Advantageously, the weighting step comprises the sum of the first, second and/or third score(s) for each of the sentences of the digital document, thus defining a semantic weight, the semantic weight of each sentence being compared with a predefined threshold in the identification step.

Advantageously, the average value of the values of the second allocation (ATT2) is in an interval representing 20% of the first interval centred on the average value of the values of the first allocation.

This configuration enables a very good relevance of the generated summary to be obtained in terms of maintaining the accuracy of the general meaning of the original text. The relationships defining the first and second intervals are significant regarding the summary which is generated and the accurate meaning of the original text which is maintained. The above described configuration results from an analysis of a great number of tests which has allowed an optimum adjustment of this configuration.

Advantageously, the average value of the values of the third allocation (ATT3) is in an interval representing 20% of the first interval centred on the average value of the values of the first allocation.

This configuration enables a very good relevance of the generated summary to be obtained in terms of maintaining the accuracy of the general meaning of the original text. The relationships defining the first and third intervals are significant regarding the summary which is generated and the accuracy of the meaning of the original text which is maintained. The above described configuration results from an analysis of a great number of tests which has allowed for an optimum adjustment of this configuration.

Furthermore, the object of the invention relates to a method for generating a digital document, known as a “digital summary”, comprising generating and displaying on a display a second set of sentences, said sentences being identified based on the identification method of the invention, according to an ordered sequence by an ascending numbering.

Advantageously, the generated digital summary comprises activatable symbols, an activatable symbol being associated with each of the sentences of the second set, the sentences of the digital summary and the activatable symbols being displayed on a display so that the activatable symbols are displayed in the proximity of the sentences, the activation of at least one activatable symbol of a selected sentence generating a second digital summary, the second digital summary comprising ordered sentences the numbering of which is successive, this set comprising said selected sentence and a first set of sentences the numbering of which precedes the one of the selected sentence and a second set of sentences the numbering of which succeeds the one of the selected sentence.

Advantageously, the activation of an activatable symbol is made by means of a computer mouse click or a cursor passing over activatable data or a tactile touch in a zone comprising the activatable symbol.

Advantageously, the activatable symbol is an alphanumeric character.

Advantageously, the activatable symbol is a number representing the number of the sentence in the first document.

Furthermore, the object of the invention relates to a method for generating a digital document, called a “digital synthesis”.

Advantageously, the method for generating a digital summary is applied to a set of digital documents in order to generate a plurality of digital summaries, said method comprising a step for generating a digital synthesis based on the definition of a parameter, a so-called distribution rate parameter, representing the quantisation of the data of each digital summary present in the synthesis and a second condensation rate of each digital summary, the digital synthesis comprising a set of ordered sentences which are selected as a function of the distribution rate and the second condensation rate of each of the digital summaries.

Furthermore, the object of the invention relates to a device for generating a digital document comprising a display for displaying at least one digital document, a computer for implementing the steps of the method of the invention. The device also comprises an interface for parameterizing at least one first condensation rate, a control system for initiating the generation of a first digital summary.

Advantageously, the control system enables the generation of a second digital summary of the first digital summary to be initiated.

Advantageously, the interface comprises a first window for displaying a set of digital documents and a second window for displaying a set of digital summaries corresponding to the summary of each document of the first window.

Advantageously, the interface comprises first means for selecting a condensation rate of a digital summary, second means for selecting a thesaurus among a predefined list of thesauruses and means for defining TAGs of a user.

### BRIEF DESCRIPTION OF THE FIGURES

Further characteristics and advantages of the invention will appear clearly from the description which is given thereafter, by way of purely indicating and in no way limitative purposes, of embodiments referring to different figures in which:

FIG. 1 represents a diagram of the main steps of the method of the invention.

### DESCRIPTION

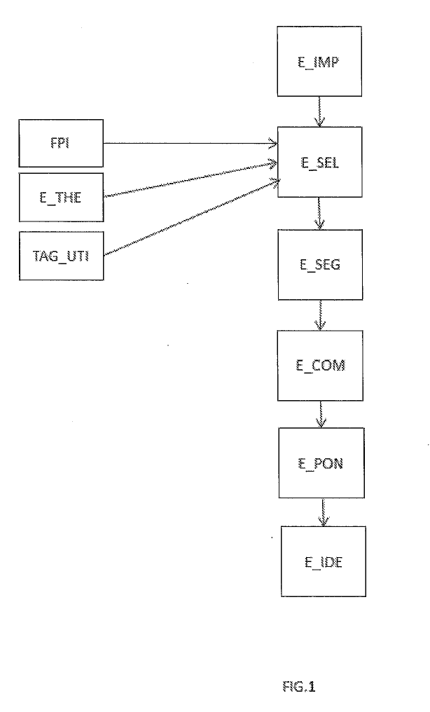

FIG. 1 represents the main steps of the method among which:
a step for importing a digital document, known as E_IMP;
a step for selecting set of files or of data from a database, such as the base of indicating sentence fragments, known as FPI, a thesaurus known as THE and defining a field's lexical field or even a list of TAGs known as TAG_UTI and defined by a user;
a step for segmenting, E_SEG, the digital document into a plurality of sentences;
a step for comparing, known as E_COM, terms or expressions of sentences of the segmented document with the TAGs of each selected file;
a weighting step, known as E_PON, for allocating a score to each sentence;
a step for identifying, known as E_IDE, sentences with a score higher than a predefined threshold;
the method of the invention possibly comprises a step for generating a digital summary, known as E_GEN, comprising the sentences identified at step E_IDE, the sentences being displayed according to a predefined sequencing.

In what follows, the description of each step of the method of the invention is described in detail. Further steps can be performed in the method in same improved embodiments of the invention.

The method of the invention comprises a step for identifying a first digital document from which one wishes to extract a set of sentences according to a certain number of criteria. The extracted sentences will enable, in an embodiment of the invention, a summary to be generated, which is called a digital summary in the rest of the description.

The method thus comprises identifying a digital document, which identification of the digital document can be performed in different ways. This document can comprise a title, a date, a language or even a plurality of languages, a reference code that can serve as an identifier. Furthermore, the document can comprise data describing its form such as its number of pages, its number of words, its layout or its format. The document must be in a digital form, that is comprising at least one set of identifiable alphanumeric characters, for example by a word processor software or an Internet browser. Any format type of the digital document is compatible with the method of the invention, namely for example a text format a html format, or even any document the formats of which are known by their abbreviation or trade name or extension among which: .doc and .docx, xls, rtf, ppt, xls, pdf or open office can be found.

The step for identifying the document can be preceded or followed by a step for importing said digital document. The importation of the digital document or a set of documents contained in a folder/directory can also be done at the same time as its identification.

Form data of the digital document can be determined by the method of the invention during the importation step.

The method thus enables at least one digital document to be imported and stored in a memory space, for example the memory of a computer component or a data server.

Storing the document can be made in a directory in an operating system of a computer.

The importation can be made by any computing means for saving the data contained in the digital document. For example, the importation can be made by copying the file, using a “copy/paste” function of an editor or also by downloading the document coming from another computer. The importation can also be made by displaying all or part of the contents of said digital document stored on a server in a browser of a local computer.

The method of the invention comprises a selection step, known as E_SEL, of a base of indicating sentence fragments also known as FPI meaning “Indicating Sentence fragments”. This base of indicating sentence fragments comprises a set of predefined linguistic TAGs, known as TAG_LIN. The linguistic TAGs can comprise term or expressions, that is a set of terms having a meaning taken together. This FPI base can be linked to a morphological dictionary which will enable all the derivations of the terms indexed in this base.

Generally speaking, in the rest of the description, a TAG is described as being a term or a set of terms forming an expression and having a syntactic or grammatical meaning.

Each linguistic TAG of the FPI comprises a first allocation of a numerical value chosen in a first interval, known as I1. The first interval is defined by a first minimum value, known as TAG_LIN_MIN and a first maximum value known as TAG_LIN_MAX.

A linguistic dictionary can be associated to the base of indicating sentence fragments for a given language. There can be a plurality of linguistic dictionaries that can be selected in the method of the invention.

Furthermore, a morphological dictionary comprises data for recognizing a linguistic TAG called a “root” or an expression comprising a plurality of terms also called a “root” for associating TAG or expression variants as a function of grammatical or conjugation rules. This data enable the TAG and/or expressions family to be gathered under a same root.

An advantage of the morphological dictionary of the invention is that it is optimized in order to enable scores to be rapidly generated with an optimized relevance. Especially, the morphological dictionary can comprise a limited number of expressions which enable a lightening of the operations of ending recognition comprised in the morphological dictionary. Furthermore, a further advantage of the morphological dictionary of the invention is to suppress the declensions of some conjugations which are not useful in the method of the invention. By way of example, the imperative mode, conjugations of the second-person singular as well as conjugations of the second-person plural are not present in the morphological dictionary. This morphological dictionary is especially adapted to the method of the invention in order to optimise the relevance of results and the calculation times.

A base of indicating sentence fragments comprises a set of linguistic TAGs, having each an allocated value representing a predefined linguistic significance degree regarding the meaning of a sentence. By way of example, the expression “to conclude” takes on a significance as to what is going to be stated just after in the sentence. Other examples can be mentioned such as: “an important thing” or also “it is essential” which are expressions comprising an allocated value close to the maximum limit of the first interval.

Consequently, the base of indicating sentence fragments comprises a first allocation, known as ATT1, of values for each TAG of the base which represents a “significance” regarding the meaning of the terms which are supposed to be exposed previously or successively to a given linguistic TAG.

The values of the first allocation are comprised in a first interval of values. The first interval is defined by a minimum value and a maximum value.

The values are preferentially predefined and manually allocated by an operator. Furthermore, they can be automatically generated according to the type of FPI base which has been selected.

In a simplified example of the invention, all the terms of a set of TAG_LIN can comprise the same allocated value, known as V1_{moy}.

The selection step of the method of the invention can also comprise the selection of a thesaurus known as THE, this step being carried out in the step E_SEL.

A thesaurus defines a file comprising a list of semantic TAGs, the TAGs being known as TAG_SEM and representing a lexical field of a predefined field. The method of the invention can comprise the selection of a plurality of thesauruses by a user.

Each of the semantic TAGs comprises a second allocation, known as ATT2, of values comprised in a second interval, known as I2, defined by a second minimum value, known as TAG_SEM_MIN and a second maximum value TAG_SEM_MAX.

In a simplified example of the invention, all the terms of a thesaurus can comprise the same allocated value, known as V2_{moy}.

The selection step of the method of the invention can also comprise the selection of a set of defined TAGs by a user defining “user TAGs”, known as TAG_UTI. The user TAGs can comprise semantic expressions and/or simple terms.

Each user TAG comprises a third allocation, known as ATT3 of values comprised in a third interval, known as I3, defined by a third minimum value (TAG_UTI_MIN) and a third maximum value (TAG_UTI_MAX).

In a simplified example of the invention, all the terms of a set of user TAGs can comprise the same allocated value, known as V3_{moy}.

The base of indicating sentence fragments can be defined in a text file or a database or any other digital file the consultation and operations of which are authorized. The same is true for the thesauruses and the sets of user TAGs.

An interface enables a user to edit a file of user TAGs or to select for example a thesaurus in a pool-down menu. The selection of a language, for example from a digital check box enables the associated thesaurus to be defined and associated.

The method of the invention comprises a step for segmenting, known as E_SEG, the first digital document for determining a first set of sentences, known as P1, of the first digital document. Upon recognizing each of the sentences of the digital document, the sentences are numbered and define a first sequence.

The segmentation step thus comprises identifying the sentences for example based on a sentence analyser which recognises each couple {punctuation mark-capital letter} in the digital document.

In an embodiment, part of the sentences of the digital document can be identified which enables the method of the invention to be applied to only a part of a digital document. For example, it is possible to limit the segmentation to one chapter of a digital document, the chapter being delimited by symbols or a font or a title enabling the part of the document to which the method is applied to be defined. The user can have at his/her disposal means for selecting a part of a text, for example through a selection with a cursor or a mouse on a digital document displayed in a display.

An advantage of being able to parameterize the part of the digital document to which the method is applied is to pre-segment a text of several chapters each dealing for example with subjects in different fields.

If the method for generating a digital summary is locally applied to a part of a document, such as a chapter for example, this enables the application of the method to different chapters and the generation of a plurality of digital summaries the contents of which can be more relevant and closer to the original meaning of the digital document.

The method of the invention can therefore comprise a pre-segmentation step for identifying parts of a document and a segmentation step for identifying all or part of the sentences of the document. This case is particularly advantageous when chapters of a digital document deal with very different subjects.

The method of the invention further enables identified sentences to be ordered, said sentences thus defining a sequence. In a preferred embodiment, the order of appearance of sentences in the first digital document is the order of the sequence of sentences during the segmentation step. In a simple embodiment, the sentences are simply numbered from the first to the last sentence of the digital document or from a part of the digital document.

The method of the invention comprises a comparison step, known as E_COM, between the terms of each sentence of the first segmented document and linguistic TAGs of the base of indicating sentence fragments and possibly declensions obtained from a morphological dictionary. This comparison step enables the presence of linguistic TAGs and their declensions to be spotted in the sentences of the original text.

In an alternative method of the invention, it is possible to carry out this comparison step on all or part of the digital document and to carry out the segmentation step later.

In an improved embodiment of the method of the invention, it is possible for each of the sentences of the segmented text from:
one or more bases of indicating sentence fragments comprising a first set of linguistic TAGs, TAG_LIN and their declensions;
one or more thesauruses comprising a second set of semantic TAGs, TAG_SEM, and;
a set of user TAGs, TAG_UTI,

to compare the terms or expressions of these last sentences with the first and/or the second and/or the third set of previously defined TAGs.

In the following description and in the definition of the invention, it is meant by “linguistic TAGs”, the “linguistic TAGs” defined in the base of indicating sentence fragments as well as their declensions deduced from a morphological dictionary when used.

The method of the invention comprises at least the selection of a first base of indicating sentence fragments defining a first set of TAGs. In order to improve the consistency of the sentences identified according to the method of the invention, a thesaurus and a set of user key words can be used.

The method of the invention enables all the terms or expressions of each sentence present in the three sets of previously defined TAGs to be listed.

The method of the invention comprises a step for weighting each sentence. The step for weighting a sentence comprises the summing of allocated values of each TAG present in said sentence, it being possible for the TAGs to come from one of the three sets of previously defined TAGs.

A weighting thus enables a quantification of the representativeness of the sentence regarding at least one FPI linked to the morphological dictionary, at least one thesaurus or at least one set of key words selected from the first digital document.

The method of the invention thus comprises a segmentation step for generating a list of ordered sentences and comprising a score obtained by the weighting step.

In an exemplary embodiment, a file constituting a base of indicating sentence fragments of words and expressions defining a first set of {TAG_LINi}_{iε[1;N]} is associated to the digital document.

Still in this exemplary embodiment, a file is selected representing a thesaurus of a field chosen by a user comprising a second set of semantic TAGs {TAG_SEMi]_{iε[1;P]} of a lexical field of this field.

An operator manually defines a third set of users {TAG_UTIi}_{iε[1;K]} that he wishes to associate to this digital document.

In this example, the three lists of TAGs {TAG_LINi}_{iε[1;N]} {TAG_SEMi}_{iε[1;P]} {TAG_UTIi}_{iε[1;K]} enable values allocated to each of the terms of each of the identified sentences in the digital document to be calculated.

The first list {TAG_LINi}_{iε[1;N]} especially enables the spotting in the digital document of expressions contextualising significant sentences, such as “to conclude”, “finally”, “let us remember that”, “it is essential that”, etc. This list is non-representative of all the possible examples but enables a precise exemplary embodiment to be defined.

Each of these expressions or terms has a defined value in a first interval which can be allocated to each term.

If the first interval is from 1 to 100, the expressions “to conclude”, “finally”, can have a value of 70 and the expressions “let us remember that”, “it is essential that” can have a value of 90.

The weighting step enables a weighting value to be allocated to each sentence of the digital document, value which is for example the sum of the values of each term or expression of the sentence which are identified in one of the sets of TAGs. For example if a sentence comprises both expressions “Finally, let us remember that . . . ”, a value of the sentence can already be 70+90=160. This sum is for the moment calculated without counting values possibly allocated to other terms of the sentence present in the other lists of TAGs.

If the thesaurus “Economy” is selected, terms such as “balance sheet”, “business plan”, “company”, “bankruptcy”, etc. can define a lexical field that one wishes to apply in extracting relevant sentences of a document. In this example, the second interval is defined by a minimum value of 0 and a maximum value of 50. In a simplified example, all the terms of the thesaurus have a value of 25.

Going back to the previous example, a sentence beginning by “Finally, let us remember that the bankruptcy of company A . . . ” cumulates the values of 70, 90, 25, and 25 and the score which is for the moment allocated to the sentence is 70+90+25+25=210.

If the user has defined a list of key words defining TAG_UTI such as “2011” or “camembert cheese”, in this example, the third interval is defined by a minimum value of 0 and a maximum value of 50. In a simplified example, all the terms of the user TAGs have a value of 25.

In the previous example, a sentence beginning by “Finally, let us remember that the bankruptcy of company A specialised in televisions is due to its surprising change of activity, especially in the camembert cheese in 2011.” cumulates the values of 70 90, 25, 25, 25, and 25 and the score allocated to this sentence is of 70+90+25+25+25+25=260.

The method comprises a step for identifying, known as E_IDE, a second set of sentences, known as P2, included in the first set of sentences P1 forming the digital document having a score higher than a first threshold.

The identification step comprises comparing each weighting of each sentence to a value defining a predefined threshold. The predefined threshold can be set in advance or modified at any time by means of an interface.

The method of the invention further comprises a thereafter defined step for parameterizing the method of the invention.

The identification step enables the generation of a second list of sentences the score of which is higher than a predefined threshold. In an alternative, it is possible to define a maximum number of sentences of the digital summary that a user wishes to define. This maximum number of sentences can be expressed as a function of a percentage of the number of sentences of the document or of the part of the document to which the method of the invention is applied. The sentences having the best scores either above a threshold, or determined by a maximum number of sentences define a second set of sentences P2.

The sentences of the second list are ordered and comprise a numbering, for example the same numbering as in the first list.

Thus, if the first list comprises for example 100 sentences numbered from 1 to 100 and only 5 sentences are retained in the second list, among which the sentences numbered 20, 30, 40, 50 and 61, their numbering can be preserved in the second list.

The method will always be able to order them for example in order to display them in a precise order by comparing the numberings of each of the sentences. It will be as simple to make the following comparison: 20<30<40<50<61, to set an order as to number again the selected sentences following the step for comparing their score with a predefined threshold.

An advantage of the second list of TAGs is that it enables the identification of the sentences of the digital document to be orientated according to a thesaurus formed by a set of TAGs representative of a precise field.

Therefore, as many digital summaries of the first digital document can be generated as different files among which one can find the FPI, a language file, a particular thesaurus or a file comprising a list of user TAGs.

The invention enables the configuration of a ratio between intervals I1, I2 and I3 or of their representative data such as the average value of the allocated values of an interval or the centre of each interval.

A first configuration consists in choosing an interval I2 included in the interval I1. Similarly, an interval I3 can be chosen so as to be included in the interval I1. That is the upper bound of the first interval I1 is higher than the upper bound of the second interval I2. Similarly, the upper bound of the first interval I1 can also be higher than the upper bound of the third interval I3.

These configurations are particularly advantageous in so far as numerous tests have been conducted in order to obtain relevant results of summaries generated with this configuration. Given that the interval I1 represents values of a set of FPI manually defined together with a morphological dictionary, this adjustment has been defined according to an analysis of a great number of results and tests. Indeed, the FPIs have been defined based on collecting and analysing sentence fragments associated to a significance of the meaning of the sentences comprising these FPIs. It is therefore understood that the adjustment of the intervals requires a significance during the configuration.

Indeed, a relevant summary can only be assessed in comparison to the reading of the original text from which it comes. To that end, numerous tests have enable intervals I1, I2 and I3 to be defined as well as their relationships for generating sentences with the best scores best reflecting the nature of the text from which the summary is generated.

A particularly advantageous configuration for optimizing the consistency and the accuracy of the digital document in identifying the sentences of the method can be defined. Especially, the definition of the maximum bound of the first interval can be taken substantially equal to half the maximum bound of the second or third interval. This configuration enables syntactic forms of a document representing topics having significance regarding the meaning to be favoured.

Advantageously, this parameterizing can be configured according to the nature of the documents which identification of the sentences is carried out by the method. For example, patent documents, scientific literature, commercial leaflets, handbooks, guides, instructions for use, books such as novels each comprise a morphological lexicon specific to the nature of the document. Consequently, characteristic data of intervals I1, I2 and I2 can be adapted on a case by case basis.

In an improved embodiment, the method of the invention comprises a preliminary parameterisation step by means of an interface enabling an operator to adapt the application of the method to the digital text according to his/her needs.

A first parameterisation comprises the definition of a first value representing the condensation degree of the digital document. This value represents a ratio between the number of sentences identified by the method of the invention and the number of sentences of the digital document or an identified part of the latter.

By best score it is meant: the highest score of a sentence when the allocated values are positively added or else scores exceeding a certain predefined threshold.

The user can for example choose to display the identified sentences with the best score and representing 10% of the number of sentences of the document. Consequently, the method of the invention will choose, out of 100 sentences of a digital document, 10 sentences with the best score.

“Condensation rate” refers to the ratio between the number of data generated in the digital summary and the number of data of the digital document. The data can be expressed as a number of characters, a number of words, a number of sentences, a number of paragraphs or even a number of pages according to the different embodiments of the invention.

The method of the invention relates to a method for identifying sentences of a digital document which can be generated according to a particular symbology in their initial context. The initial context is defined by the displaying of a sentence among the other sentences of the digital document, that is normally when the text of the document is simply displayed.

The particular symbology can relate to a colour, a font or a font size. Therefore, when the method is applied for example to a digital text displayed in an Internet browser, the sentences identified according to the method of the invention can appear in bold type with the font size higher than the font size of the non-identified sentences. Other demarcation sensibilities facilitating the so-called “cursory” reading of a text can be combined together. The generation of the identified sentences according to the method of the invention with a particular symbology so that they can be recognisable, when they are generated in their initial context, can be so in any display or any digital display software such as a digital editor or browser.

The invention enables identified sentences to be generated in the same font but with a variation of formats corresponding to calculated scores for each of the sentences. For example, the sentences having a more substantial score will be allocated a bigger display. The sentences having a less substantial score will be allocated a smaller display. A gradation of this display is applied to the entire source document. The sentences that can convey significant information are displayed in bigger fonts. Conversely, those of a lesser significance are displayed in smaller fonts. A magnitude scale of this display will enable the user to browse the document and/or its summary in a single glance.

The method can be applied to a corpus of N digital documents, for example, by generating a digital summary of all the sentences of all the digital documents. It is also possible to specify a condensation rate for each of the documents. The method then executes the method of the invention on a list of documents and then enables the display of a digital synthesis. The digital synthesis is the juxtaposition of a plurality of digital summaries generated by the method of the invention applied to several digital documents.

The digital synthesis is generated by the method of the invention to which two further steps have been added. There is then a first parameterisation step for specifying the condensation rate of each digital summary contributing to the creation of the digital synthesis. There is a synthesis creation step by the juxtaposition of a plurality of digital summaries.

Let's take for example three digital documents D1, D2, D3 for which the method is executed in order to generate a digital synthesis. The method of the invention is applied to each of the digital documents by specifying in the parameterisation of an interface the condensation rate of each of the summaries of each of the documents.

For example, a first summary R1 comprises a condensation rate of 20% of D1, a second summary R2 comprises a condensation rate of 10% of D2, a third summary comprises a condensation rate of 5% of D1. The digital synthesis S1 then comprises the juxtaposition of the three summaries R1, R2 and R3.

The invention comprises a device for generating at least one digital summary. The latter comprises computing means for implementing the steps of the method, a display for displaying the digital document and/or the digital summary. Furthermore, the device of the invention comprises means for selecting parameters of the configuration or the parameterisation of the method.

Furthermore, the display can comprise a browser having:
a first window for displaying on the one hand, a plurality of symbols representing documents ordered according to a given sequence and, on the other hand, titles or references of documents in order to make them identifiable;
a second window for displaying summaries of each of the documents, the summary being generated by means of the method of the invention.

In the second window, the displaying order of the summaries, for example are below the other, can be faithful to the displaying sequence of the document. Thus, for a user, there is a consistency between the displaying order of the documents or their symbols in a first window and the summaries which are in a second window preferentially arranged next to the first window.

In an embodiment, a symbol is generated in the proximity of each sentence of the digital summary. Each symbol is activatable by selecting means controlled by a user such as a mouse and a cursor or a tactile touch on a touch screen.

The symbol can be one or more alphanumeric character(s), for example such as “+” or “−” signs. Each symbol can be generated in the proximity of each of the sentences of the digital summary. The symbols can all be generated in the same part, for example to the left or the right of the summary displayed on the same line as the beginning or the end of a sentence. They can also be displayed in the text of the digital summary after each point or capital letter of the text.

The activation of these signs enables the display of consecutive or previous sentences of the sentence positioned near the sign to be generated. This characteristics enables a sentence which would have lost meaning during its extraction from the digital document to be contextualised.

Besides, a double click on a sentence of the generated summary enables its suppression from the list of retained sentences for the case where the user would not wish to have this sentence at his/her disposal in the final summary.

Thus, the device of the invention provides a simple means for the user to recover a consistency and accuracy degree of the digital summary regarding the digital document by a quick and simple action.

An activation of the sign enables the immediate display of the previous sentence and/or the sentence following the sentence associated with an activated symbol. A double click on the sentence enables its removal from the display.

According to the parameterisation performed, an action on a sign enables the display of one or more sentences before or after the sentence for which one wishes to clarify the context. This data is parameterisable in an embodiment.

Finally, the invention comprises numerous advantages. The definition of the TAG_LIN of the base of indicating sentence fragments enables the method to take into account expressions and terms which represent a significance form in extracting significant points, that is sentences, of a document which depend on the morphological structure of a given language.

The thesaurus enables the generation of a summary to be orientated according to a particular semantic axis, for example the automobile field. Finally, the user key words enable considerations of specific researches of an individual to be taken into account.

Thus, each digital summary according to the criteria for selecting files and/or defining TAGs enables a “customized” summary to be generated. The latter is generated with an accuracy and a consistency, regarding the digital document, that can be corrected or contextualised.

1. A method for identifying a set of sentences of a first digital document, comprising:
importing a first digital document in at least one predefined format for: either displaying the document in a first interface or storing it in a memory;
selecting a base of indicating sentence fragments comprising a set of linguistic TAGs, each of the linguistic TAGs comprising a first allocation of numerical values chosen in a first interval defined by a first minimum value and a first maximum value;
selecting a thesaurus defining a file comprising a list of semantic TAGs of a field, each of the semantic TAGs comprising a second allocation of values for each semantic TAG included in a second interval defined by a second minimum value and a second maximum value, the second maximum value being lower than the first maximum value of the first interval;
segmenting the first digital document for:
determining a first set of sentences of the first document;
numbering the sentences of the first set defining a first sequence;
comparing terms of each sentence of the first segmented document and linguistic TAGs of the base of indicating sentence fragments enabling the presence of linguistic TAGs to be spotted in said sentences;
weighing each of the sentences by allocating a first score corresponding to a sum of the values of each spotted linguistic TAG in each of the sentences;
weighing each of the sentences further comprising allocating a second score corresponding to a sum of the values of each semantic TAG spotted in each of the sentences;
identifying a second set of sentences included in the first set of sentences,
a sum of the first and the second scores of the sentences of the second set of sentences being higher than a first threshold.

2. The method for identifying a set of sentences of a digital document according to claim 1, wherein the first threshold is calculated from a condensation rate defined by a number of sentences desired by a user of the second set out of a total number of sentences of the first set of sentences.

3. The method for identifying a set of sentences of a digital document according to claim 1, wherein the first threshold is calculated from a condensation rate defined by a number of terms wished by a user of the second set of sentences out of a total number of terms of the first set of sentences.

4. The method for identifying a set of sentences of a digital document according to claim 2, wherein an interface enables the condensation rate to be configured.

5. The method for identifying a set of sentences of a first digital document according to claim 1, comprising displaying by an interface the first digital document, the displaying comprising generating sentences identified according to a font size larger that non-identified sentences.

6. The method for identifying a set of sentences of a first digital document according to claim 1, wherein the comparing comprises determining root terms of the linguistic TAGs of the indicating sentence fragments from a morphological dictionary and comparing declensions of the root terms of the linguistic TAGs with each sentence of the digital document.

7. The method for identifying a set of sentences of a first digital document according to claim 1, wherein:
the selecting comprises selecting a set of TAGs defined by a user defining user TAGs comprising semantic expressions and/or terms, each of the user TAGs comprising a third allocation of values for each user TAG included in a third interval defines a third minimum value and a third maximum value; and
weighing each of the sentences by allocating a third score corresponding to the sum of the values of each user TAG spotted in each of the sentences.

8. The method for identifying a set of sentences of a first digital document according to claim 1, wherein the weighing comprises a sum of the first, second and/or third scores for each of the sentences of the digital document, thus defining a semantic weight, the semantic weight of each sentence being compared with a predefined threshold in the identifying.

9. The method for identifying a set of sentences of a first digital document according to claim 1, wherein an average value of the values of the second allocation is in an interval representing 20% of the first interval centred on an average value of the values of the first allocation.

10. The method for identifying a set of sentences of a first digital document according to claim 1, wherein an average value of the values of the third allocation is in an interval representing 20% of the first interval centred on an average value of the values of the first allocation.

11. A method for generating a digital summary, comprising generating and displaying on a display the second set of sentences, said sentences being identified based on the identification method of claim 1, according to a sequence ordered by an ascending numbering.

12. The method for generating a digital document according to claim 11, wherein the generated digital summary comprises activatable symbols, an activatable symbol being associated with each of the sentences of the second set, the sentences of the digital summary and the activatable symbols being displayed on the display so that the activatable symbols are displayed in the proximity of the sentences, the activation of at least one activatable symbol of a selected sentence generating a second digital summary, the second digital summary comprising ordered sentences the numbering of which is successive, the set comprising said selected sentence and a first set of sentences the numbering of which precedes the one of the selected sentence and a second set of sentences the numbering of which succeeds the one of the selected sentence.

13. The method for generating a digital document according to claim 12, wherein the activation of an activatable symbol is made by a computer mouse click or a cursor passing over activatable data or a tactile touch in a zone comprising the activatable symbol.

14. The method for generating a digital document according to claim 12, wherein the activatable symbol is an alphanumeric character.

15. The method for generating a digital document according to claim 12, wherein the activatable symbol is a number representing the number of the sentence in the first document.

16. A method for generating a digital synthesis, comprising applying the method according to claim 11 to a set of digital documents in order to generate a plurality of digital summaries, said method comprising generating a digital synthesis based on the definition of a distribution rate representing a quantisation of the data of each digital summary present in the synthesis and of a second condensation rate of each digital summary, the digital synthesis comprising a set of ordered sentences which are selected as a function of the distribution rate and of the second condensation rate of each of the digital summaries.

17. A device for generating a digital document comprising a display for displaying at least one digital document, a computer for implementing steps of the method of claim 1, an interface for parameterizing at least one first condensation rate, and a control system for initiating the generation of a first digital summary.

18. The device for generating a digital document according to claim 17, wherein the control system enables the generation of a second digital summary of the first digital summary to be generated.

19. The device for generating a digital document according to claim 17, wherein the interface comprises a first window for displaying a set of digital documents and a second window for displaying a set of digital summaries corresponding to the summary of each document of the first window.

20. The device for generating a digital document according to claim 17, wherein the interface comprises first means for selecting a condensation rate of a digital summary, and second means for selecting a thesaurus among a predefined list of thesauruses and means for defining TAGs of a user.
